(19) United States
(12) Patent Application Publication
(10) Pub. No.: US 2026/0119975 A1
(43) Pub. Date: Apr. 30, 2026

(54) CALIBRATION OF AI MODEL EVALUATION METRICS

(71) Applicant: SAP SE, Walldorf (DE)

(72) Inventor: Chinmay Kakatkar, Munich (DE)

(21) Appl. No.: 18/933,013

(22) Filed: Oct. 31, 2024

(51) Int. Cl. G06N 20/00

(52) U.S. Cl. CPC G06N 20/00

(57) ABSTRACT

Methods, systems, and apparatus, including medium-encoded computer program products, for calibration of evaluation metrics of a machine learning model, include: obtaining an evaluation metric indicative of accuracy of outputs of a machine learning model; determining an adjustment for the evaluation metric based on invoking a calibration model to estimate an error of the evaluation metric of the machine learning model, wherein the error is estimated in an execution context of a first application running in a platform environment; adjusting the evaluation metric according to the determined adjustment; and in response to determining the adjusted evaluation metric is above a threshold value, providing instructions to provide an output of an execution of the machine learning model based on input data obtained from the execution context of the first application, the input data being related to a process flow defined at the first application.

### TECHNICAL FIELD

The present disclosure relates to computer-implemented methods, software, and systems for data processing.

### BACKGROUND

Software applications can provide services and access to resources. Software applications can provide services to end users and expose interfaces that allow for user interaction and data input. Software applications can store obtained data from users, for example, in tabular format at data stores. Artificial intelligence (AI) can find implementations in different use cases in the context of data processing and/or data imputation. For example, processes executed by software applications can be automated based on the use of machine learning models. Machine learning (ML) models may be trained to provide outputs that can be input into a process running at a software application to automate the execution. ML model's performance may be considered to determine whether to rely on the output to automate process execution. However, the performance of ML models may depend on the context of their use. As such, evaluation of the performance of ML models in different contexts may be needed.

### SUMMARY

The present disclosure describes mechanisms to implement a calibration of an evaluation metric associated with performance of a machine learning model.

In general, one or more aspects of the subject matter described in this specification can be embodied in one or more methods (and also one or more non-transitory computer-readable mediums tangibly encoding a computer program operable to cause data processing apparatus to perform operations), including: obtaining an evaluation metric indicative of accuracy of outputs of a machine learning model; determining an adjustment for the evaluation metric based on invoking a calibration model to estimate an error of the evaluation metric of the machine learning model, wherein the error is estimated in an execution context of a first application running in a platform environment; adjusting the evaluation metric according to the determined adjustment; and in response to determining the adjusted evaluation metric is above a threshold value, providing instructions to provide an output of an execution of the machine learning model based on input data obtained from the execution context of the first application, with the input data being related to a process flow defined at the first application.

The described subject matter can be implemented using a computer-implemented method; a non-transitory, computer-readable medium storing computer-readable instructions to perform the computer-implemented method; and a computer-implemented system comprising of one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. In accordance with implementations of the present disclosure, outputs of a machine learning model can be accurately evaluated based on a calibrated evaluation metric. The calibrated evaluation metric provides an evaluation that more closely reflects the performance of the machine learning model when used in the context of a particular application. As such, fewer computational resources (e.g., compute cycles) are required for training the machine learning model to achieve an output accuracy above a threshold.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 depicts an example system in accordance with implementations of the present disclosure.

FIG. 2 is a block diagram illustrating an example of a computer-implemented system for generating adjusted evaluation metrics of a machine learning model, according to an implementation of the present disclosure.

FIG. 3 is a flowchart illustrating an example of a computer-implemented method for providing a prediction from a machine learning model based on an adjusted evaluation metric, according to an implementation of the present disclosure.

FIG. 4 is a flowchart illustrating an example of a computer-implemented method for identifying machine learning models for re-training over context specific data, according to an implementation of the present disclosure.

FIG. 5A is a block diagram illustrating an example user interface form provided for user interaction and input of field values at one or more fields, according to an implementation of the present disclosure.

FIG. 5B is a block diagram illustrating an example user interface form provided for user interaction that implements logic for automatic data imputation based on a trained model, according to an implementation of the present disclosure.

FIG. 6 is a block diagram illustrating an example of a computer-implemented system for calibrating an evaluation metric of a machine learning model, according to an implementation of the present disclosure.

FIG. 7 is a block diagram illustrating an example of a computer-implemented system for calibrating an evaluation metric of a machine learning model, according to an implementation of the present disclosure.

FIG. 8 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes methods for calibrating an evaluation metric. The evaluation metric indicates the accuracy of outputs provided by executing a machine learning model. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted, so as to not obscure one or more described implementations. The present disclosure is not intended to be limited to the described or illustrated implementations, but to be accorded the widest scope consistent with the described principles and features.

A machine learning model can provide predictive outputs based on a previously unseen data set received as input. The machine learning model is trained on training data with similar attributes as the unseen data. For example, machine learning models can be trained to provide predictions for the execution of processes in various contexts, including statistical analysis, system performance, or approval processes within a transaction or organizational context, among other examples. In some instances, predictive outputs from machine learning models can be used to improve the speed of process execution within a system environment. For example, a process can be implemented by one or more computer programs, and multiple instances of the process can be executed. Based on collected past observations of the process, a machine learning model can be trained to predict process outputs. The outputs provided by a trained model can be based on an identification of a data pattern in an input data set and can include a recommendation for performing a given action, or outputting a data value as a prediction, among other examples. Outputs obtained from executing trained models can be used to automate a process execution for example at an instantiated application or service, and thus, the process can be performed with fewer resource requirements including, computation resources, resources to interact with users or other entities, and processing power, as well as time.

For example, an application can expose a user interface form(s) that includes fields that can be filled in by users or through other external input. Filling in data in such user interface forms can be a time-consuming task that is error-prone. In some instances, a machine learning model can be trained to provide predicted values that can be input in a user interface form instead of obtaining the user's input for those values or other external input. The output of the trained machine learning model can represent a recommendation for a value to be filled in the user interface form. Possible inaccuracies in the data recording or issues upon execution of requests in view of data discrepancy can lead to inefficiency in process and task executions. In some instances, the accuracy of the machine learning model can depend on the context where the model is executed. It can be expected that some machine learning models can provide better accuracy in certain fields and particular contexts, but underperform in others. Thus, the machine learning model's performance can be evaluated to determine whether it meets an expected threshold to determine whether to use the outputs of the model in a productive context, such as, to use it to automate the filling in of data in the user interface forms.

Trained models can be evaluated to determine their performance, for example, their accuracy. To evaluate the performance (e.g., accuracy) of a trained machine learning model, a test data set (e.g., a segment of context-specific data that can be omitted from the training data used for the training) can be obtained (e.g., can be generated or extracted from real historical data) to be used to perform the model performance evaluation. Based on executing the performance evaluation, respective evaluation metrics can be determined for the model. Evaluation metrics associated with outputs of the trained machine learning model can include mean absolute error (MAE), precision, F1 score, etc. The specific evaluation metrics can depend on the type of data represented in the training data and the type of generated output, e.g., numerical or categorical outputs.

In some cases, training data used for training a machine learning model may not be representative of a specific use case or application context of a user, but rather can be generic and available for use into multiple contexts. As such, the performance of the trained model may diverge in a different context. For example, when the trained model is used to provide a prediction based on data obtained from a given application or an application process, it can provide 90% accurate results, while when used for executing the same prediction logic but based on input data from a different application, it can provide 80% accurate results. Further, when a trained model is tested, the testing data may include similar characteristics as the training data (e.g., obtained from the same context(s) and/or having the same distribution of the values in the training data, among other examples). As such, obtained performance evaluation metrics for the model based on the test data may not be representative of the performance of the model if used over an input set that originates from a different context or from a narrower context within the scope of the training and/or testing data. Given such possible discrepancies between the evaluation metrics determined by processing the test data set (that can include arbitrary data, e.g., associated with processing executed in different contexts from different execution environments) and a specific performance of the model in an application environment, e.g., associated with specific context data that may not have the same characteristics of the training and/or testing data used for the generation and evaluation of the model. In some cases, the presence of such discrepancies can lead to performance issues when the machine learning model is used to automate process execution but has a performance level below the expected or predefined level for the automated task (e.g., filling in data in a user interface form).

In some instances, when a model is determined to be used in a particular context, the model is associated with a particular evaluation metric that describes the performance of the particular model in relation to a training context. For example, the particular model can be trained based on training data that includes data from a context that is identical to the particular context where the model is going to be used. As another example, the particular model can be trained based on training data that includes data that belongs to a similar context, where the similar context includes some differences in comparison with the particular context where the model is going to be used. The differences can include differences in the distribution of data occurrences that correspond to characteristics of other similar contexts. As another example, the particular model can be trained on training data that is not decipherable as to pertaining to a given context but rather it is generic training data (e.g., associated with multiple contexts) that is used to optimize the performance of the trained model as a generic model rather than a context specific model. As such, relying on the obtained particular evaluation metric for the performance of a given trained model cannot always be sufficient to determine if the outputs of the model qualify to be used in the automation of tasks or processed related to the particular context of the intended use case. For example, the training data associated with the training context may not overlap perfectly with the particular context of the intended use case, requiring a calibration of the evaluation metric to reflect the expected performance of the model in the particular context of the intended use case.

Filling in a form can be performed in the context of a human-computer interaction, where in some instances, a machine learning model can be used in the context of user interface forms, where data and/or values are filled in during a human-computer interaction, where the user provides input data to perform operations of a procedure that requires input and relies on implemented logic (e.g., the machine learning logic) for guiding the user in executing the procedure and providing the relevant data as recommendations or output to automate the process. User interface forms can be associated with storing data in tabular form, and based on such stored tabular data, an inference can be made for recommending field values to be provided for fields where values are missing in accordance with implementations of the present disclosure. To support a user in the tasks of filling in such user interface form, an intelligent inference system can be created that understands the specifics of the application and the use of the user interface form so that the user can be provided with recommendations for values to be filled in the user interface form for fields that have not been provided with field values by the user or otherwise (e.g., based on fixed rules) in a more reliable yet efficient manner. In some instances, machine learning models can be evaluated to determine which one to use in the context of automating the process of filling in data in the fields, or machine learning models can be evaluated to determine whether to apply targeted fine-tuning or re-training to adjust the model's logic to provide outputs that are associated with higher accuracy.

In some cases, and in the context of an application providing a user interface form for triggering a process (e.g., generating a shipping order to instruct a shipment of goods), missing values of the not yet filled-in user interface form that is initiated to be filled in by a user, cannot be ignored or omitted. While missing values can be imputed based on approaches, such as filling in missing values with a constant value (e.g., default value, or dynamically obtained value from another application or user) or using a most commonly used value or an average value in a dataset. Such approaches may be associated with a higher rate of inaccuracy compared to intelligent approaches based on machine learning models that are trained on particular application data and/or user style of interactions.

For example, the user interface form can include fields for which values as required, and these values can be imputed by obtaining data from a trained machine learning model to fill in the form. The obtained data from the trained machine learning model can be recommended values by the trained machine learning model and thus associated with a certain level of accuracy.

In some instances, a calibration metric can be calculated for the machine learning model to adjust the performance evaluation metric of the model so that it can be determined how the model would perform in the specific context of an application. Although there are many use cases that benefit from a determination of a calibrated evaluation metric of a trained machine learning mode, a particular example is the use case of imputing values in missing fields of a user interface form, where the calibrated evaluation metric associated with the model is used to determine if the corresponding outputs of the trained model meet a required threshold to be utilized in the user interface form.

Aside from the example use case of considering a calibrated evaluation metric associated with a machine learning model to determine if the corresponding outputs should be used for filling in fields of a user interface form, other example use cases exist. For example, a system can generate automated reports by implementing a trained machine learning model, where a calibrated evaluation metric based on the use case of generating automated reports can be used to determine if the trained machine learning model is acceptable for the use case (e.g., meets a predefined acceptance criteria). Furthermore, similar applications include triggering alarms of a system, where the triggering is in response to receiving an output from a trained machine learning model that can determine a severity of an event to trigger an alarm. In some instances, multiple trained machine learning models may be available for use to provide output that can be included in another process or other execution. In some instances, the calibration metric can support selecting a model from the available models that would provide outputs with the highest level of accuracy in the particular context. For example, even if the models may be associated with a generic accuracy level, that accuracy may not be applicable in the context of an application, and thus the calibration metric can support a decision for selection of one of the models instead of the other(s).

In accordance with implementations of the present disclosure, a method for calibrating evaluation metrics associated with outputs of a machine learning model according to a particular context of the use of the machine learning model is needed. In some instances, the machine learning model can provide outputs based on input data that is obtained from the particular context of use. In some instances, a machine learning model can be used in the particular context to provide an output (e.g., a recommended data value) together with a label indicative of the accuracy of the output (e.g., a calibrated evaluation metric), where the output can be used for execution of a process flow, for example, upon evaluation of the accuracy of the output. In some instances, the calibrated evaluation metric can determine if a trained machine learning model is suitable for execution in the particular context. The determination of whether to use or not use the machine learning model can be performed based on evaluating a provided performance metric for the machine learning model and calibrating it to the context, without considering the type of training data or techniques to train the model. In some instances, it can be determined, based on the calibrated evaluation metric, that a trained machine learning should be re-trained and/or fine-tuned to be acceptable for use in executions or automation in the particular context. In some instances, the calibrated evaluation metric can inform a selection between multiple trained machine learning models in relation to execution in a particular context.

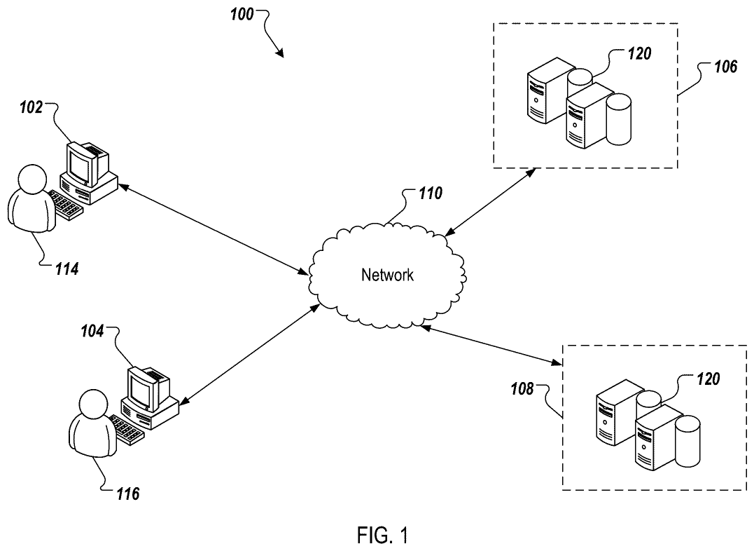

FIG. 1 depicts an example system 100 in accordance with implementations of the present disclosure. In the depicted example, the example system 100 includes a client device 102, a client device 104, a network 110, an environment 106, and an environment 108. The environment 106 and the environment 108 may be cloud environments. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device, such as a desktop computer, a laptop computer, a handheld computer, a tablet computer, a personal digital assistant (PDA), a cellular telephone, a network appliance, a camera, a smart phone, an enhanced general packet radio service (EGPRS), mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some instances, the environment 106 includes at least one server and at least one data store 120. In the example of FIG. 1, the environment 106 is intended to represent various forms of servers, including but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications that can provide user interfaces, including user interface forms that implement machine learning techniques described in the present application, to support automatic data imputation. In some instances, the environments 106 and 108 may execute operations according to the calibration techniques described in the present application that support a calibration of evaluation metrics associated with outputs of a trained machine learning model. In some instances, the calibration techniques can include training a calibration machine learning model based on training data that is generated for a set of data attributes indicative of an execution context for applying the machine learning logic (e.g., in the context of a client application hosted by one or more of the environments 106 and 108). In some instances, the training data includes data associated with collected historical observations obtained from the execution context of the hosted application. Examples of parameters of a particular execution context include data types, data group sizes, and cardinalities of target fields of the user interface form of the client application, etc.

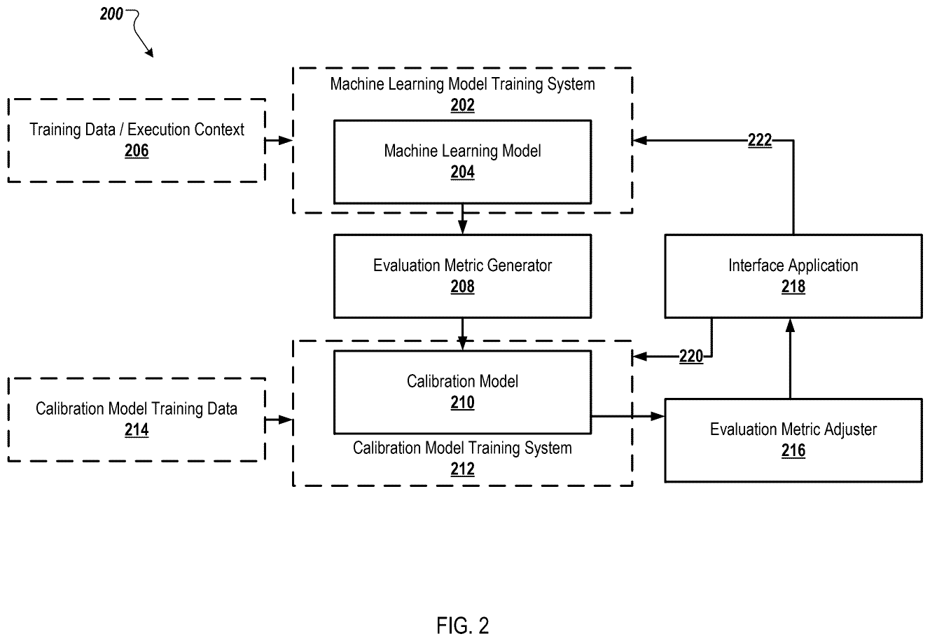

FIG. 2 is a block diagram of an example computer-implemented system 200 for calibrating evaluation metrics associated with outputs of a trained machine learning model. The system 200 includes at least one processor (e.g., a processor of a computing device of the environment 106 or 108 of FIG. 1) that implements operations of a machine learning model 204 that generates predictive outputs. In some instances, the predictive outputs correspond to a prediction of a recommended value to be input into a user interface field of a client application (e.g., a client application hosted by the environment 106 or 108 of FIG. 1). In a general sense, each system component of FIG. 2 represents one or more computational operations executed by a processor of a system, e.g., system 100, that includes one or more processors (e.g., a processor of a computational device of environment 106 or 108, a processor associated with the client device 102, etc.).

A machine learning model training system 202 can train the machine learning model 204 using training data 206 that corresponds to one or multiple execution contexts. For example, the training data 206 can include example scenarios of data input into the user interface as part of a first operation of a particular process flow (e.g., filling a sales order) and a prediction of values to be filled in as a second operation of the process flow based on the data of the first operation. The particular process flow can be unique to one or more of a particular user, use case, customer, application, or other context definition. In some cases, the training data associated with a particular execution context (e.g., training data received based on past executions within a given execution context) can yield a trained machine learning model associated with an evaluation metric that is different from an observed evaluation metric when it is executed as part of a particular application.

In some instances, the machine learning model training system 202 trains the machine learning model 204 based on training data associated with multiple execution contexts (e.g., multiple sets of training data 206) for one or multiple applications, services, or software systems. For example, two execution contexts can be associated with a single field of a particular user interface, where each execution context is associated with a different user. For example, a first execution context can be associated with a first use case associated with a first user (e.g., the first execution context can include user-specific data associated with the first user). A second execution context can be associated with a second use case associated with a second user (e.g., the second execution context can include user-specific data associated with the second user). Although the field of the user interface can be populated by a shared machine learning model, a calibrated evaluation metric associated with the model may be different when calibrated based on the first execution context in comparison with the second execution context. As such, the system may determine that an output of the trained machine learning model is suitable to populate the field for one of the users and not the other.

An evaluation metric generator 208 determines one or more evaluation metrics associated with the accuracy of the trained machine learning model 204. In some instances, a subset of the training data 206 is allocated for testing and/or evaluation to determine the accuracy of the trained machine learning model 204. In some instances, the testing data belongs to the same execution context as the training data 206. In other words, the evaluation metric generator 208 evaluates the accuracy of the trained machine learning model 204 in the context of which it is trained. In some instances, the testing data is generic and/or not related to the type of data used for the training of the model. For example, the evaluation metric generator 208 may perform generic evaluation of the trained machine learning model 204 to determine performance by processing testing data that includes different characteristics that do not pertain to a single context or application specific data.

In some instances, the evaluation metric generator 208 generates at least one evaluation metric based on comparing the outputs of the trained machine learning model 204 with the expected outputs of the trained machine learning model 204. In some instances, an evaluation metric can be compared to a pre-defined threshold value to determine if the trained machine learning model 204 is accurate enough to be deployed in an application (e.g., a business software application that can include a reporting application, marketing/sales application, logistics application, etc.). For example, the pre-defined threshold value can be provided as a criterion for evaluation of the model to determine its suitability for deployment in the application. The pre-defined threshold value can be provided by an external component, system, or user. For example, a particular field of a user interface can be associated with a pre-defined threshold, as defined during the design or definition of the interface. For each input to the particular field by a trained machine learning model, the system can first determine if a calibrated evaluation metric meets the pre-defined threshold value of the particular field. As another example, a user (e.g., a user of the application or a user associated with the management of the application), can request a comparison of the pre-defined threshold value and the calibrated evaluation metric to determine if a trigger should be sent to a system to re-train and/or fine-tune the trained machine learning model. In some instances, the request can be through a user interface or through an automated evaluation trigger (e.g., based on an evaluation schedule).

A calibration model 210 processes the outputs of the evaluation metric generator 208. The calibration model 210 can be trained within a training system, such as a calibration model training system 212. The calibration model 210 can be trained to determine an adjustment to the evaluation metric generated by the evaluation metric generator 208. In some instances, the calibration model training system 212 trains the calibration model 210 with calibration model training data 214 that is obtained by collecting historical observations from an application. The observations are a result of real-world and/or simulated usage of the application. The calibration model training data 214 is a representation of an execution context that is realized during the execution of the machine learning model 204 as part of a process flow of an application environment. For example, the calibration model training data 214 can include collected data for a user interface form filled in by a user while interacting with an application, where the collected data corresponds to multiple fields of the form. In some instances, the collected data is stored in a database of an application system, where the database stores records for objects and/or entities associated with the executed process flow defined for the system logic of the application. For example, as a user interacts with the user interface form (e.g., creates multiple sales order forms by filling in the form), the application system can store the filled in data in the database, and the stored data can later be used as the calibration model training data 214 associated with a particular execution context (e.g., the execution context relates the particular use case of the user filling in the user interface form to generate sales order forms).

In some instances, the calibration model 210 is based on a foundation model that can be shared across multiple execution contexts. For example, the foundation model can be used to calibrate evaluation metrics associated with predicted outputs from two distinct trained machine learning models that are trained based on training data with common features (e.g., creation of sales orders and creation of sales quotations). In this example, the two distinct trained machine learning models are trained on similar data (e.g., data that includes shared fields, data value ranges, categorical variables, etc.). By sharing the foundation model across multiple specific use cases, machine learning resources (e.g., compute resources for training, storage of model weights, etc.) can be deployed more efficiently. In some instances, the foundation model can be fine-tuned to a particular execution context, which can be more computationally efficient than training a machine learning model that does not rely on a foundation model or other pre-trained model as a starting point. As such, by fine-tuning the foundation model, a training system (e.g., the calibration model training system 212) can determine an initial set of model parameters (e.g., weights of each layer of a neural network) based on the model parameters of the foundation model. A set of model parameters that correspond to the trained machine learning model associated with the particular execution context can be determined with fewer computational resources because the training system is initialized with a set of parameters that correspond to a foundation model that is pre-determined based on a similar execution context (e.g., compared to initializing the set of model parameters with random values).

In some instances, the execution context of the calibration model training data 214 is described as a set of m data attributes, X={x₁, x₂, . . . , xₘ}. The set of data attributes represents the context of the calibration training data 214. The calibration model 210 processes the set of data attributes (e.g., by evaluating a function ƒ(X)) and outputs a prediction \hat{δ}, which represents a difference between a first evaluation metric determined by testing the trained machine learning model 204 on testing data and a second evaluation metric determined based on observed outputs in an application environment.

In some instances, the calibration model training system 212 trains the calibration model 210 based on calibration model training data 214 that includes one or more data features. The data features are derived from the observations and can include a combination of one or more observed data attributes. In some instances, the calibration model training system 212 can execute operations associated with one or more feature engineering methods. The feature engineering methods can include a Pareto Reoccurrence method, a group composability method, and a group spatial density method. The Pareto Reoccurrence method includes a two-step algorithm that first determines a number of y distinct elements that reoccur in at most x distinct groups in a dataset. For a maximum number of distinct groups in the dataset (n), a grouping is defined by one or more “group ID” fields (e.g., a primary key of the grouping). A function r(x)=y can be interpreted as a Pareto curve, in which y is the number of distinct elements in the dataset that occur in x distinct groups. The method includes a second step that determines how quickly the Pareto curve plateaus. In other words, the second step determines the smallest number of distinct groups xₗ such that r(xₗ)≈r(xₗ+1). Implementation of the Pareto Reoccurrence method results in groupings of data elements of the dataset, in which the groupings are processed by the calibration model 210 as predictive features.

The group composability method includes an iterative process that computes multiple combinations of data elements of the data set that result in each data grouping of a set of groups of data elements, in which a set of k groupings are defined as D={G₁, . . . , Gₖ}. The group composability method results in a descriptive group of statistics of group composability (i.e., group combinations) that can include a minimum, maximum, median, mode, standard deviation, and percentile statistics in relation to the number of possible ways to form a particular set of data groupings. In some instances, the calibration model 210 processes the descriptive group of statistics generated by the group composability method as predictive features of the calibration training data 214.

The group spatial density method includes an iterative process that maps each element of a grouping of data elements to a space of embedding vectors. For example, the method includes a set of k groupings, D={G₁, . . . , Gₖ} and maps each element of group Gᵢ to the embedding space. After the mapping, the method includes computing a spatial density of elements within each group (i.e., how close or spread out the elements in a respective group are to each other when represented in the embedding space). The group spatial density method results in a descriptive group of statistics of group spatial density that include minimum, maximum, median, mean, standard deviation, and percentile statistics in relation to the density of the groupings as represented in the embedding space. In some instances, the calibration model 210 processes the descriptive group of statistics generated by the group spatial density method as predictive features of the calibration training data 214.

In some instances, a user initiates a request (e.g., through a user interface of an interface application 218) to evaluate the accuracy of the machine learning model 204. In response to the request, the evaluation metric generator 208 generates a corresponding evaluation metric associated with the outputs of the machine learning model 204. The trained calibration model 210 processes the corresponding evaluation metric and generates a calibrated calibration metric. An evaluation metric adjuster 216, which is communicatively coupled with the trained calibration model 210, processes the output of the trained calibration model 210 to generate an adjusted evaluation metric. In some instances, in response to determining the adjusted calibration metric is above a threshold value, the interface application 218 provides an instruction to output the execution of the machine learning model 204 based on input data obtained from the execution context of an application, in which the input data is related to a process flow of the application. In other words, if the adjusted evaluation metric is indicative of the machine learning model 204 that outputs predictions with sufficient accuracy, the outputs of the machine learning model 204 are used to provide predictions/outputs to the application. In some instances, the threshold value is determined based on data in the request, while in other instances, the threshold value is determined based on a system variable. In some instances, in response to determining the adjusted calibration metric is below a threshold value, the interface application 218 provides an instruction to the calibration model training system 212 to re-train and/or fine-tune the machine learning model 204.

In some instances, an interface of the interface application 218 is exposed (e.g., a user interface or an application programming interface (API)) to process requests for evaluating evaluation metrics associated with the machine learning model 204 (e.g., as part of a machine learning/artificial intelligence lifecycle pipeline). The evaluation metrics can be generated for different execution contexts of a particular application. For example, the different execution contexts can pertain to different users, use cases, data types, etc. The interface application 218 can determine adjusted evaluation metrics by invoking the trained calibration model 210 (illustrated as data path 220) to estimate an error of the evaluation metrics of the machine learning model 204 for each of the different execution contexts. In response to determining that an evaluation metric for a respective execution context of the application is below a pre-defined threshold, the interface application 218 can provide instructions to re-train the machine learning model 204 (illustrated as data path 222) based on the respective training data 206 associated with the respective execution context.

In some instances, an interface (such as a user interface or an API) can be configured to serve requests for processing evaluation metrics of a given machine learning model in one or multiple execution contexts. In some instances, the evaluation metrics of the machine learning model can be calibrated for the one or multiple execution contexts based on respective calibration models that are trained to estimate errors of the evaluation metrics for the different execution contexts. In some instances, the interface can receive a request for evaluation of the evaluation metrics of the machine learning model, such as the machine learning model 204, in a particular execution context. The execution context can be identified, for example, through a user selection of available contexts to be used for the calibration. The execution context can be identified based on a provided identifier of the relevant context(s), e.g., identifier of a client account, identifier of a user, identifier of an application, or other identification of a process or context related to an application execution, etc. In some instances, the interface can receive a request to evaluate an evaluation metric of the machine learning model in relation to a given context (e.g., associated with a process defined at a software application, or associated with an account at a software system) and invoke the execution of calibration of the evaluation metric for that context. The calibration can be invoked by identifying a calibration model that is trained for calibrating evaluation metrics for the given context. In some instances, a different calibration model can be provided for one or multiple contexts to provide calibration of evaluation metrics upon receiving a request. In some instances, the calibrations of evaluation metrics performed based on requests at the interface can be used to evaluate the performance of the machine learning model in different execution contexts. Upon evaluation of the calibrations and determining the performance of the model in various contexts, it can be determined whether to initiate training (retraining or fine-tuning) of the machine learning model based on training data relevant for one or more of the execution contexts. For example, a difference between the evaluation metric and a calibrated evaluation metric for a given execution context that is above a threshold difference value can trigger a process for re-training or fine-tuning of the model for that particular context.

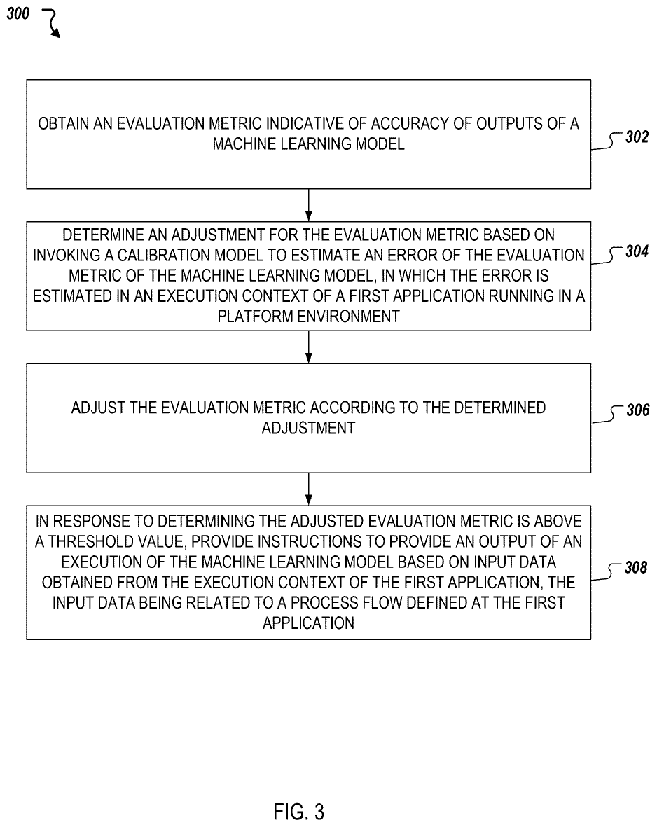

FIG. 3 is a flowchart illustrating an example of a computer-implemented method 300 for calibrating an evaluation metric associated with an output of a machine learning model, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. For example, the method 300 can be performed at a server of environment 106 of FIG. 1. In some implementations, various operations of method 300 can be run in parallel, in combination, in loops, or in any order.

At 302, the system obtains an evaluation metric indicative of accuracy of outputs of a machine learning model. In some instances, the system evaluates the accuracy of outputs by processing test data (e.g., a segment of training data) and comparing the outputs with the expected outputs of the test data. In some instances, evaluation metrics indicate how well the machine learning model is expected to perform in an environment in which the model is deployed for use by an application.

At 304, the system determines an adjustment for the evaluation metric based on invoking a calibration model to estimate an error of the evaluation metric of the machine learning model, in which the error is estimated in an execution context of a first application running in a platform environment.

In some instances, the calibration model is trained based on training data that is generated for a set of data attributes indicative of an execution context specific to an application. For example, the training data can include data and/or features derived from data associated with collected historical observations from the execution context of the application. In some instances, the execution context includes variables that are specific to a particular user or use case. For example, in the context of providing recommended field values related to a process flow of a user interface, execution context variables can include a number of selectable options for a particular field and cardinalities of particular fields. In some instances, the calibration model is trained to predict an error level of the evaluation metric of the machine learning model, when the machine learning model provides predictions based on input data associated with executed process flows at the application. In other words, as a user inputs data into data fields of a user interface, the machine learning model can predict likely values to input into the remaining fields. The remaining fields and options for each field can be specific to a particular execution context (e.g., user, role, application, etc.).

At 306, the system adjusts the evaluation metric according to the determined adjustment. In some instances, the output of the calibration model is indicative of a difference between the evaluation metric and an evaluation metric that is predicted to better represent an application scenario. In the case in which there is a discrepancy between the calculated evaluation metric and the predicted evaluation metric, the system can determine an adjusted evaluation metric to better represent the accuracy of the machine learning model in the execution context that relates to the application scenario.

At 308, in response to determining the adjusted evaluation metric is above a threshold value, the system provides instructions to provide an output of the execution of the machine learning model based on input data obtained from the execution context of the first application, the input data being related to a process flow defined at the first application.

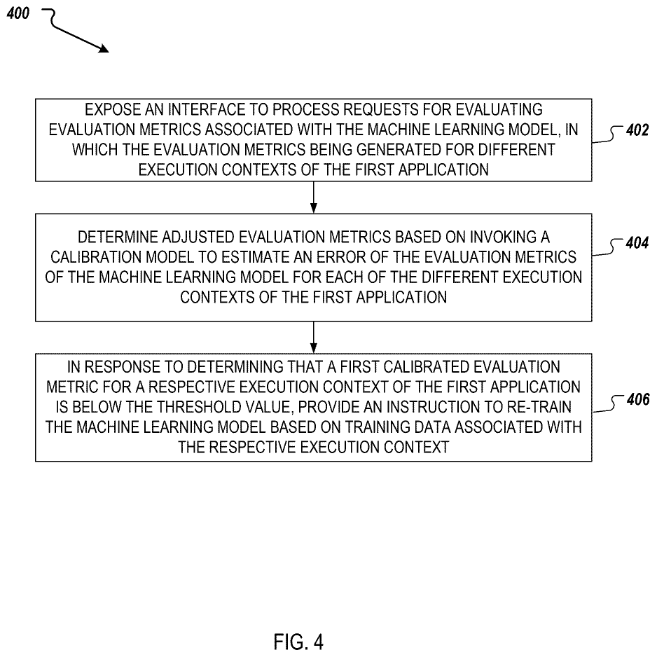

FIG. 4 is a flowchart illustrating an example of a computer-implemented method 400 for providing an instruction to re-train a machine learning model, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various operations of method 400 can be run in parallel, in combination, in loops, or in any order.

At 402, the system exposes an interface to process requests for evaluating evaluation metrics associated with the machine learning model, in which the evaluation metrics are generated for different execution contexts of an application. In some instances, the interface can be configured to support the evaluation of evaluation metrics associated with the machine learning model by performing calibration of the evaluation metrics in one or more of a set of available execution contexts (e.g., associated with an application, service, account, user role, etc.).

At 404, the system determines adjusted evaluation metrics based on invoking a calibration model to estimate an error of the evaluation metrics of the machine learning model for each of the different execution contexts of the application. In some instances, in response to receiving a first request at the interface for calibrating a first evaluation metric associated with the machine learning model in a first execution context of the set of available execution contexts, a first calibrated evaluation metric for the machine learning model can be determined. The first calibrated evaluation metric can be determined based on invoking the calibration model as a first calibration model of the set that is associated with the first execution context. The first calibration model can be configured to estimate an error of the evaluation metric of the machine learning model for the first execution context. In some instances, the first calibration model can be selected from the set of available execution context, as a model associated with the relevant execution context for which the request is received.

At 406, in response to determining that a first calibrated evaluation metric for a respective execution context of the application is below a threshold value, the system provides an instruction to re-train the machine learning model based on training data associated with the respective execution context. In some instances, based on the evaluation metric for the first execution context and the first calibrated evaluation metric meeting a criterion for updating the machine learning model, an instruction to re-train the machine learning model can be provided. The re-training can be performed based on training data associated with the first execution context.

In some instances, in response to determining that the first calibrated evaluation metric is above a threshold value, instructions can be provided to provide the output of an execution of the machine learning model for which the evaluation metric is received at 404 at the interface. The output of the execution of the machine learning model can be generated based on input data related to a process flow defined at the first application. The process flow defined at the first application can be considered as the relevant context execution for which the calibration of the execution metric is performed. The machine learning model can be further fine-tuned or re-trained based on data associated with the context execution to further calibrate and improve the model to provide more accurate output for the context of the process flow.

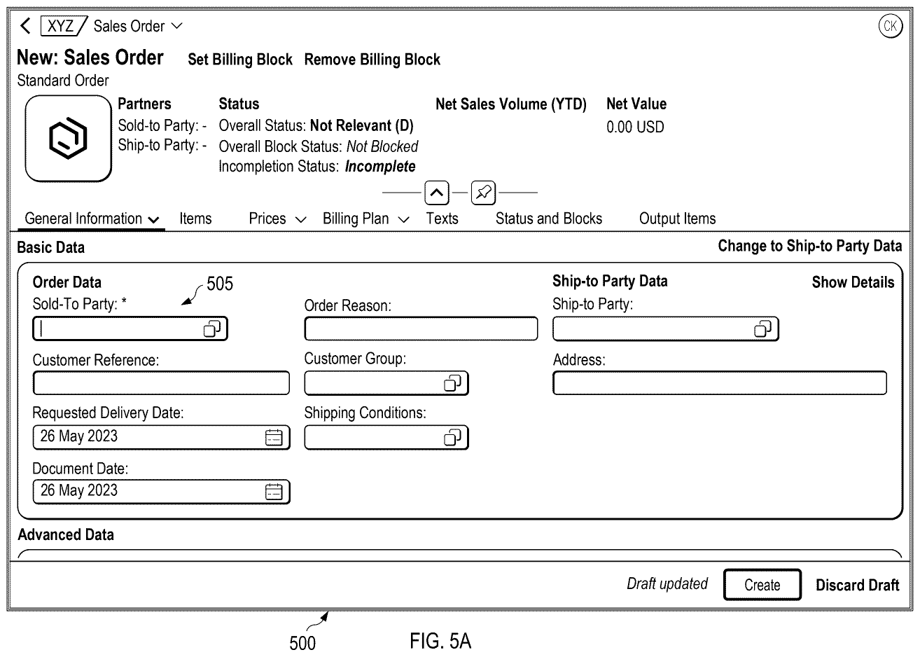

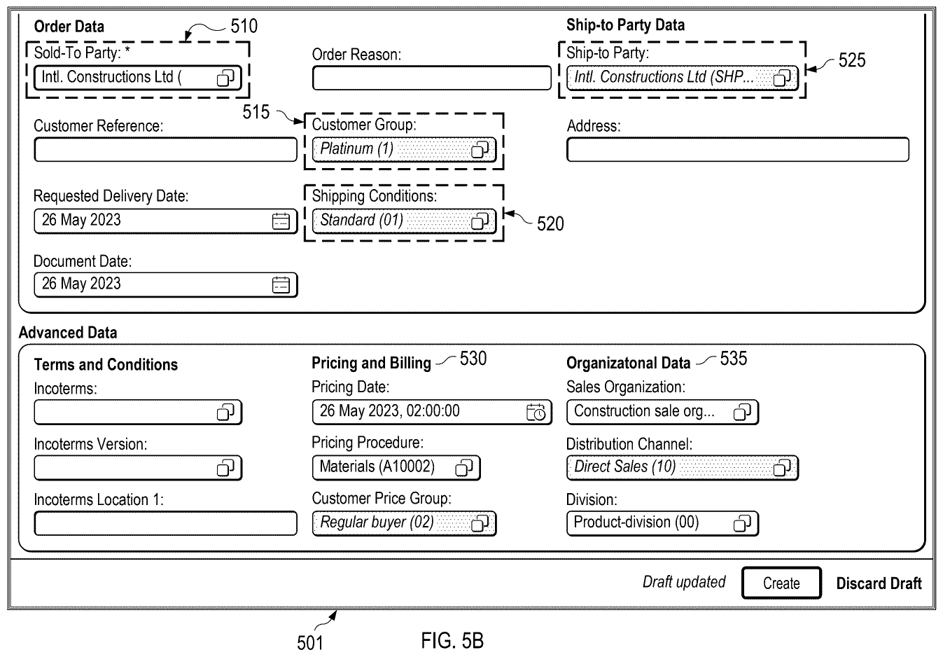

FIG. 5A is a block diagram illustrating an example user interface form 500 provided for user interaction and input of field values at one or more fields, according to an implementation of the present disclosure. The example user interface form 500 is a form provided as part of an application for generating sales orders. The user interface form 500 implements “smart” logic for recommending data entries in the form while a user is entering their input, in the form of recommendations in accordance with implementations of the present disclosure. For example, the user interface form 500 can support providing data imputation based on an output of a trained machine learning model. The trained machine learning model can be trained based on training data specific to an execution context of the application. For example, the training data can include input data and output data specific to fields related to the user interface form 500 and the related process flow of generating sales orders.

In some instances, the user interface form 500 can be provided on a user interface for a display device of a user, where the user interface can be provided by an application such as a sales application, when requested to create a new sales order. The sales orders generated through the user interface form 500 can be stored in a tabular data object at a data storage, such as a database. The user interface form 500 can receive user input and can provide recommendations for imputing tabular data in the user interface form 500 so that upon completion of the sales order creation, the data as provided in the user interface form 500 can be stored as a row in a tabular data object defined for the user interface form 500.

The user interface form 500 includes a data field that is “Sold-to Party” 505 field, where a user can provide input to initiate the creation of a sales order. For example, some fields that are part of the user interface form 500 can be automatically populated upon initiation of the creation of a sales order, such as a requested delivery date, or a document date. The field values for such fields can be determined automatically based on preconfigured rules. In the example of the requested delivery date and document date field, a rule can be defined to input a current date of creation of the sales order as the field value. The user interface form 500 can include other data fields that are empty, as shown in FIG. 5A, which can be filled in with values based on user interactions. Such user input for data fields can trigger the invocation of a trained machine learning model to support the filling in of the sales order and to predict values for fields, for which no input was provided as recommendations for the entries that can be confirmed or modified by a user filling in the user interface form 500.

FIG. 5B is a block diagram illustrating an example user interface form 501 for user interaction that implements the logic for automatic data imputation based on a trained machine learning model (e.g., the trained machine learning model 204 of FIG. 2), according to an implementation of the present disclosure. The example user interface form 501 can be an updated version of the user interface form 500 that is generated upon input of data by a user to fill in the Sold-to Party 510 field with a field value, such as “Intl. Constructions Ltd.”. In that example, when the user had entered the field value for the Sold-to Party 510, a trained model can be invoked to predict values for one or more other user interface fields of the user interface form 500 based on the first field value for the first field and to provide those predicted values as recommendations for values in the user interface form 501. In the example of the user interface form 501, recommendations based on predicted values for fields Customer Group 515, Shipping Conditions, and Ship-to Party 525 are provided for fields part of the order data section of the user interface form 501. In some cases, other fields of the user interface form 501 can be filled in with recommendations based on predicted values as output by the trained model. The recommended values as provided on the user interface form 501 can be highlighted in a particular color, marked, or otherwise annotated to indicate to the user that such fields are automatically input as recommendations and are not user input data.

In some instances, the user interface form 501 can include labels indicative of the accuracy of the recommendations provided as output by the trained model. A predicted value for the Customer Group 515 field can include the recommended value along with a label indicative of an evaluation metric associated with a machine learning model that outputs the predicted value. In some instances, the label is implemented as a percentage, a colored interface element, or a message to the user.

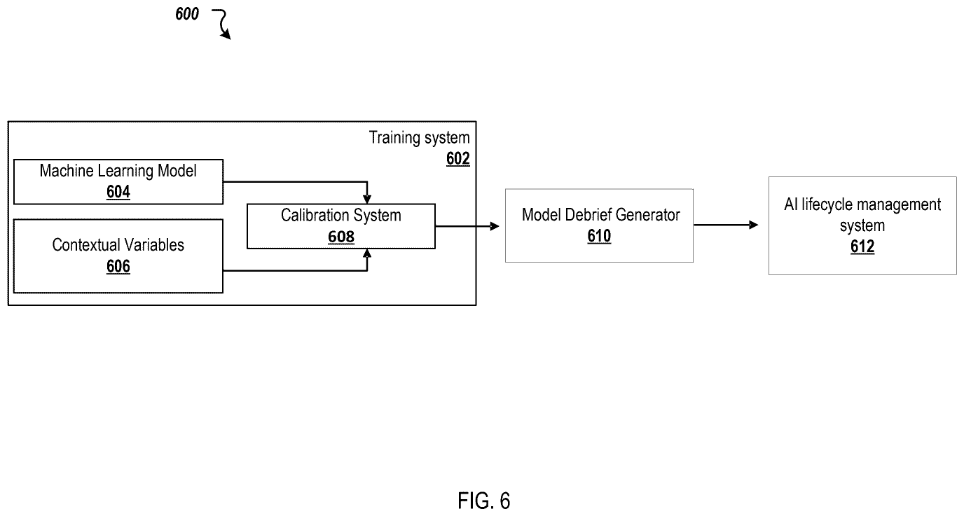

FIG. 6 is a block diagram of an example computer-implemented system 600 for generating a calibrated evaluation metric of a trained machine learning model. The calibrated evaluation metric can be provided as an input to an artificial intelligence (AI) lifecycle management system 612 for incorporation into processes of selecting a trained model for use in a particular context, for evaluation of the performance of models in a given context, for performing a selection or filtering of trained models for use in contexts associated with one or more computing environment where one or more applications and services can perform processes that can be automated based on model output data. In some instances, by identifying a calibrated evaluation metric for a trained model to determine whether to use the model in a given context, the accuracy of the process execution can be improved as well as the computation resources associated with the execution can be more efficiently utilized.

The system 600 includes at least one processor (e.g., a processor of a computing device of the environment 106 or 108 of FIG. 1) that implements operations of one or more machine learning models that generates predictive outputs, machine learning training systems, and other data processing tasks. In a general sense, each system component of FIG. 6 represents one or more computational operations executed by a processor of a system, e.g., system 100, that includes one or more processors (e.g., a processor of a computational device of environment 106 or 108, a processor associated with the client device 102, etc.).

A training system 602 trains a machine learning model 604 to output a predicted value. In the context of the present disclosure, the predicted values can include one or more data fields of a user interface related to a particular process flow of an application. However, the machine learning model 604 trained by the training system 602 is applicable to generating predictive outputs for any application type.

The training system 602 trains the machine learning model 604 based on training data specific to a particular execution context. The execution context is represented by one or more data attributes that represent an implementation of an application, process flow, and/or use case. The training system 602 computes contextual variables 606 related to the training data, where the training data is used by the training system 602 to train the machine learning model 604. The contextual variables 606 can include variables that describe the predictive outputs (e.g., data types, data ranges, categorical variables, etc.) and variables that describe attributes of the training data.

The training system 602 includes a calibration system 608 that applies a calibration to one or more evaluation metrics. For example, the applied calibration can be performed as described in relation to FIG. 3. The evaluation metrics reflect an accuracy of the predictive outputs generated by the machine learning model 604. In some instances, the training system 602 determines the evaluation metrics by processing a test data set and comparing the predicted outputs of the trained machine learning model 604 with expected outputs, as reflected in the test data set. In some instances, the calibration includes processing the evaluation metrics with a trained calibration machine learning model to determine a predicted difference between the processed evaluation metrics and evaluation metrics that are expected to be observed in relation to a deployed machine learning model in an application. In some instances, the calibration machine learning model processes the computed contextual variables 606 along with the generated evaluation metrics.

A model debrief generator 610 generates calibrated evaluation metrics based on the output of the calibration system 608 (e.g., based on an output of a calibration machine learning model). In some instances, the processors associated with the model debrief generator 610 are different from the processors that implement the operations of the training system 602. In some cases, the evaluation metrics are organized in a model debrief, which provides a summary of performance metrics related to the execution of the trained machine learning model 604.

Based on the calibrated evaluation metrics (i.e., calibrated model debrief) as generated by the model debrief generator 610, a subsequent operation of an AI lifecycle management system 612 can be initiated. In some instances, the system 612 compares a calibrated evaluation metric to a threshold value to determine if a subsequent operation is initiated. In some instances, the system 612 compares a calibrated evaluation metric to a threshold value to determine if the machine learning model 604 is sufficiently accurate to provide outputs to an application. In some instances, the system 612 compares a calibrated evaluation metric to a threshold value to determine if the machine learning model 604 should be re-trained using new training data, a subset of existing training data, or based on a modified training procedure.

The training system 602 includes the training process of the machine learning model 604 and the calibration process that can include processing the contextual variables 606 and predictive outputs of the machine learning model 604 as part of a common training system 602. In some instances, the operations executed in relation to the machine learning model 604 and the calibration system 608 are performed by one or more processors of a shared infrastructure (training system 602), in which the processors can access common data stores and computational processes. As such, the training system 602 can iteratively modify characteristics (e.g., weights, model architecture, training procedures, etc.) of the machine learning model 604 in response to calibrated evaluation metrics generated by the calibration system 608 to iteratively improve the performance of the trained machine learning model 604.

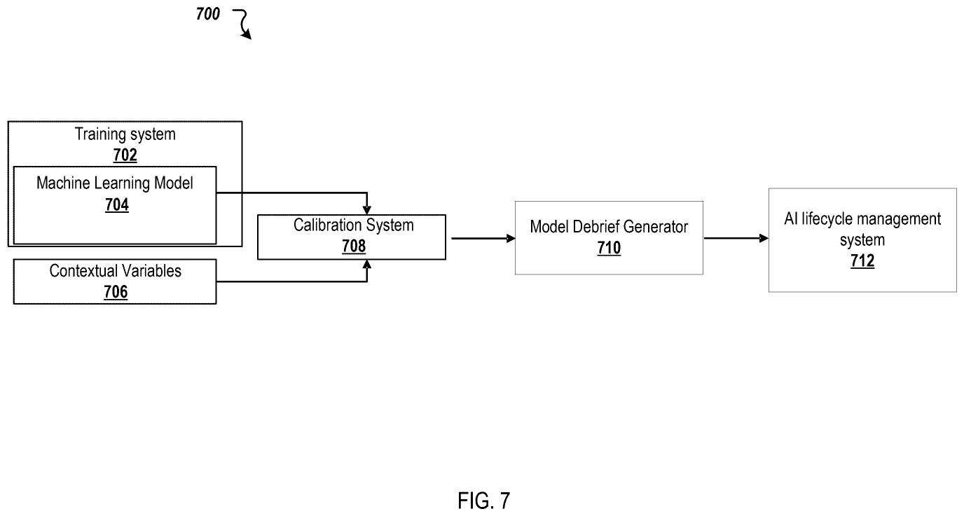

As an alternative configuration, in some instances, a training system does not have access to calibrating evaluation metrics, as depicted in FIG. 7.

FIG. 7 is a block diagram of an example computer-implemented system 700 for generating a calibrated evaluation metric of a trained machine learning model. The calibrated evaluation metric is an input to an AI lifecycle management system 712. The system 700 includes at least one processor (e.g., a processor of a computing device of the environment 106 or 108 of FIG. 1) that implements operations of one or more machine learning models that generates predictive outputs, machine learning training systems, and other data processing tasks. In a general sense, each system component of FIG. 7 represents one or more computational operations executed by a processor of a system, e.g., system 100 of FIG. 1, that includes one or more processors (e.g., a processor of a computational device of environment 106 or 108, a processor associated with the client device 102 of FIG. 1, etc.).

Similar to the system 600 described in relation to FIG. 6, the training system 702 performs a training process in relation to a machine learning model 704. In some instances, the execution of requests for outputs from the trained machine learning model 704 includes a request to provide evaluation metrics related to the machine learning model. As described in relation to the previous figures, evaluation metrics are indicative of the accuracy of the trained machine learning model 704. In some instances, upon receiving a request for a predictive output, the machine learning model 704 outputs the predictive output and performs an evaluation metric generation process to output an associated evaluation metric in addition to the predictive output.

In contrast to the training system 602, the training system 702 does not access calibrated evaluation metrics and contextual variables 706 or a calibration system 708. The machine learning model 704 generates a predictive output and an associated evaluation metrics independent of the contextual variables 706 without performing a calibration procedure of the calibration system 708.

In response to receiving a predictive output, the calibration system 708 generates calibrated evaluation metrics, as described in relation to the calibration system 608. Based on the calibrated evaluation metrics, a model debrief generator 710 generates a model debrief, as described in relation to the model debrief generator 610. Based on the generated model debrief, the AI lifecycle management system 712 can determine if a subsequent operation of the lifecycle should be initiated, as described in relation to the system 612.

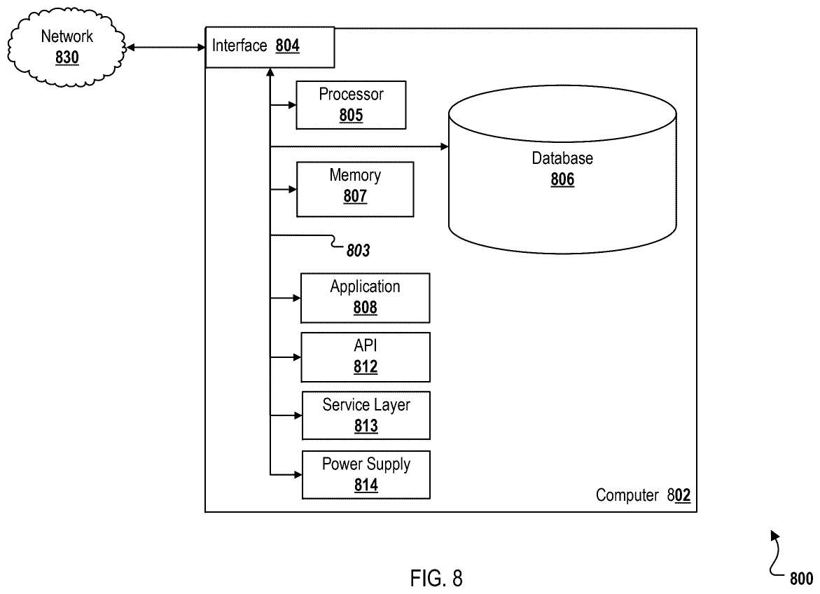

FIG. 8 is a block diagram illustrating an example of a computer-implemented system 800 used to provide computational functionalities associated with described algorithms, methods, functions, processes, flows, and procedures, according to an implementation of the present disclosure. In the illustrated implementation, computer-implemented system 800 includes a Computer 802 and a Network 830.

The illustrated Computer 802 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 802 can include an input device, such as a keypad, keyboard, or touch screen, or a combination of input devices that can accept user information, and an output device that conveys information associated with the operation of the Computer 802, including digital data, visual, audio, another type of information, or a combination of types of information, on a graphical-type user interface (UI) (or GUI) or other UI.

The Computer 802 can serve in a role in a distributed computing system as, for example, a client, network component, a server, a database, another persistency, or a combination of roles for performing the subject matter described in the present disclosure. The illustrated Computer 802 is communicably coupled with a Network 830. In some implementations, one or more components of the Computer 802 can be configured to operate within an environment, or a combination of environments, including cloud-computing, local, or global.

At a high level, the Computer 802 is an electronic computing device operable to receive, transmit, process, store, or manage data and information associated with the described subject matter. According to some implementations, the Computer 802 can also include or be communicably coupled with a server, such as an application server, e-mail server, web server, caching server, streaming data server, or a combination of servers.

The Computer 802 can receive requests over the Network 830 (for example, from a client software application executing on another Computer 802) and respond to the received requests by processing the received requests using a software application or a combination of software applications. In addition, requests can also be sent to the Computer 802 from internal users (for example, from a command console or by another internal access method), external or third-parties, or other entities, individuals, systems, or computers.

Each of the components of the Computer 802 can communicate using a System Bus 803. In some implementations, any or all of the components of the Computer 802, including hardware, software, or a combination of hardware and software, can interface over the System Bus 803 using an API 812, a Service Layer 813, or a combination of the API 812 and Service Layer 813. The API 812 can include specifications for routines, data structures, and object classes. The API 812 can be either computer-language independent or dependent and refer to a complete interface, a single function, or even a set of APIs. The Service Layer 813 provides software services to the Computer 802 or other components (whether illustrated or not) that are communicably coupled to the Computer 802. The functionality of the Computer 802 can be accessible for all service consumers using the Service Layer 813. Software services, such as those provided by the Service Layer 813, provide reusable, defined functionalities through a defined interface. For example, the interface can be software written in a computing language (for example JAVA or C++) or a combination of computing languages and providing data in a particular format (for example, extensible markup language (XML)) or a combination of formats. While illustrated as an integrated component of the Computer 802, alternative implementations can illustrate the API 812 or the Service Layer 813 as stand-alone components in relation to other components of the Computer 802 or other components (whether illustrated or not) that are communicably coupled to the Computer 802. Moreover, any or all parts of the API 812 or the Service Layer 813 can be implemented as a child or a sub-module of another software module, enterprise application, or hardware module without departing from the scope of the present disclosure.

The Computer 802 includes an Interface 804. Although illustrated as a single Interface 804, two or more Interfaces 804 can be used according to particular needs, desires, or particular implementations of the Computer 802. The Interface 804 is used by the Computer 802 for communicating with another computing system (whether illustrated or not) that is communicatively linked to the Network 830 in a distributed environment. Generally, the Interface 804 is operable to communicate with the Network 830 and includes logic encoded in software, hardware, or a combination of software and hardware. More specifically, the Interface 804 can include software supporting one or more communication protocols associated with communications such that the Network 830 or hardware of Interface 804 is operable to communicate physical signals within and outside of the illustrated Computer 802.

The Computer 802 includes a Processor 805. Although illustrated as a single Processor 805, two or more Processors 805 can be used according to particular needs, desires, or particular implementations of the Computer 802. Generally, the Processor 805 executes instructions and manipulates data to perform the operations of the Computer 802 and any algorithms, methods, functions, processes, flows, and procedures as described in the present disclosure.

The Computer 802 also includes a Database 806 that can hold data for the Computer 802, another component communicatively linked to the Network 830 (whether illustrated or not), or a combination of the Computer 802 and another component. For example, Database 806 can be an in-memory or conventional database storing data consistent with the present disclosure. In some implementations, Database 806 can be a combination of two or more different database types (for example, a hybrid in-memory and conventional database) according to particular needs, desires, or particular implementations of the Computer 802 and the described functionality. Although illustrated as a single Database 806, two or more databases of similar or differing types can be used according to particular needs, desires, or particular implementations of the Computer 802 and the described functionality. While Database 806 is illustrated as an integral component of the Computer 802, in alternative implementations, Database 806 can be external to the Computer 802. The Database 806 can hold and operate on at least any data type mentioned or any data type consistent with this disclosure.

The Computer 802 also includes a Memory 807 that can hold data for the Computer 802, another component or components communicatively linked to the Network 830 (whether illustrated or not), or a combination of the Computer 802 and another component. Memory 807 can store any data consistent with the present disclosure. In some implementations, Memory 807 can be a combination of two or more different types of memory (for example, a combination of semiconductor and magnetic storage) according to particular needs, desires, or particular implementations of the Computer 802 and the described functionality. Although illustrated as a single Memory 807, two or more Memories 807 or similar or differing types can be used according to particular needs, desires, or particular implementations of the Computer 802 and the described functionality. While Memory 807 is illustrated as an integral component of the Computer 802, in alternative implementations, Memory 807 can be external to the Computer 802.

The Application 808 is an algorithmic software engine providing functionality according to particular needs, desires, or particular implementations of the Computer 802, particularly with respect to the functionality described in the present disclosure. For example, Application 808 can serve as one or more components, modules, or applications. Further, although illustrated as a single Application 808, the Application 808 can be implemented as multiple Applications 808 on the Computer 802. In addition, although illustrated as integral to the Computer 802, in alternative implementations, the Application 808 can be external to the Computer 802.

The Computer 802 can also include a Power Supply 814. The Power Supply 814 can include a rechargeable or non-rechargeable battery that can be configured to be either user- or non-user-replaceable. In some implementations, the Power Supply 814 can include power-conversion or management circuits (including recharging, standby, or another power management functionality). In some implementations, the Power Supply 814 can include a power plug to allow the Computer 802 to be plugged into a wall socket or another power source to, for example, power the Computer 802 or recharge a rechargeable battery.

There can be any number of Computers 802 associated with, or external to, a computer system containing Computer 802, each Computer 802 communicating over Network 830. Further, the terms “client,” “user,” or other appropriate terminology can be used interchangeably, as appropriate, without departing from the scope of the present disclosure. Moreover, the present disclosure contemplates that many users can use one Computer 802, or that one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The terms “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate, such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and the time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be or further include special-purpose logic circuitry, for example, a central processing unit (CPU), a graphics processing unit (GPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example, LINUX, UNIX, WINDOWS, MAC OS, ANDROID, or IOS, or a combination of operating systems.

A computer program, which can also be referred to, or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that describe features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, a GPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from, or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media, and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated into special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, or in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### EXAMPLES

Although the present application is defined in the attached claims, it should be understood that the present invention can also be (alternatively) defined in accordance with the following examples:

Example 1. A computer-implemented method, the method comprising:
obtaining an evaluation metric indicative of accuracy of outputs of a machine learning model;
determining an adjustment for the evaluation metric based on invoking a calibration model to estimate an error of the evaluation metric of the machine learning model, wherein the error is estimated in an execution context of a first application running in a platform environment;
adjusting the evaluation metric according to the determined adjustment; and
in response to determining the adjusted evaluation metric is above a threshold value, providing instructions to provide an output of an execution of the machine learning model based on input data obtained from the execution context of the first application, the input data being related to a process flow defined at the first application.

Example 2. The method of Example 1, comprising:
training the calibration model based on training data generated for a set of data attributes indicative of the execution context at the first application, wherein the training data includes data associated with collected historical observations from the execution context of the first application.

Example 3. The method of Example 2, wherein the calibration model is trained to predict an error level of the evaluation metric of the machine learning model when providing predictions based on input data associated with executed process flows at the first application.

Example 4. The method of any one of the preceding Examples, wherein providing the instructions comprises:
providing the output together with a label indicative of the accuracy of the output to the first application for execution of the process flow, wherein the label is determined based on the adjusted evaluation metric.

Example 5. The method of Example 4, wherein the first application is configured to execute the process flow based on obtaining data from a user and the output of the execution of the machine learning model.

Example 6. The method of any one of the preceding Examples, wherein providing the instructions comprises:
querying the machine learning model to generate the output based on a request received from the first application, the machine learning model being conditioned based on at least a portion of the obtained input data related to the process flow.

Example 7. The method of any one of the preceding Examples, wherein the first application includes a user interface associated with tabular data objects stored at a respective storage associated with a user interface form, wherein each data object of the tabular data object corresponds to a respective user interface field of the user interface form, wherein providing the instructions comprises:
displaying the output in an associated field of the user interface fields on the user interface form during executing the process flow associated with the user interface form.

Example 8. The method of any one of the preceding Examples, wherein the execution context of the first application for which the error of the evaluation metric is estimated is a first execution context of a plurality of different execution contexts of the first application, and wherein the method comprises:
exposing an interface to process requests for evaluating evaluation metrics associated with the machine learning model, wherein the evaluating of the evaluation metrics is performed for the plurality of different execution contexts of the first application;
in response to determining that the adjusted evaluation metric for the first execution context of the first application is below the threshold value, providing an instruction to re-train the machine learning model based on training data associated with the first execution context.

Example 9. A computer-implemented method comprising:
exposing an interface to serve requests for calibrating evaluation metrics associated with a machine learning model in one or more of a set of available execution contexts;
in response to receiving a first request at the interface for calibrating a first evaluation metric associated with the machine learning model in a first execution context of the set of available execution contexts, determining a first calibrated evaluation metric for the machine learning model based on invoking a first calibration model associated with the first execution context, wherein the first calibration model is configured to estimate an error of the evaluation metric of the machine learning model for the first execution context; and
in response to determining that the first evaluation metric for the first execution context and the first calibrated evaluation metric meet a criterion for updating the machine learning model, providing an instruction to re-train the machine learning model based on training data associated with the first execution context.

Example 10. The method of Example 9, wherein the first calibrated evaluation metric is indicative of accuracy of outputs of the machine learning model in the first execution context.

Example 11. The method of Example 9 or Example 10, wherein determining the first calibrated evaluation metric comprises:
selecting the first calibration model from the set of calibration models trained for evaluating the first evaluation metric.

Example 12: The method of any one of Example 9 to Example 11, wherein determining the first adjusted evaluation metric for the machine learning model comprises:
obtaining the first evaluation metric;
determining an adjustment for the first evaluation metric based on invoking the first calibration model, wherein the first execution context is a context defined in relation to a first application running in a platform environment; and
adjusting the first evaluation metric according to the determined adjustment to determine the first calibrated evaluation metric;
wherein the method further comprises:
   in response to determining the first calibrated evaluation metric is above a threshold value, providing instructions to provide an output of an execution of the machine learning model based on input data obtained from the execution context of the first application, the input data being related to a process flow defined at the first application.

Example 13. A non-transitory, computer-readable medium storing one or more instructions executable by a computer system to perform one or more operations according to the method of any one of Examples 1 to 12.

Example 14. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations according to the method of any one of Examples 1 to 12.

What is claimed is:

1. A computer-implemented method, the method comprising:
obtaining an evaluation metric indicative of accuracy of outputs of a machine learning model;
determining an adjustment for the evaluation metric based on invoking a calibration model to estimate an error of the evaluation metric of the machine learning model, wherein the error is estimated in an execution context of a first application running in a platform environment;
adjusting the evaluation metric according to the determined adjustment; and
in response to determining the adjusted evaluation metric is above a threshold value, providing instructions to provide an output of an execution of the machine learning model based on input data obtained from the execution context of the first application, the input data being related to a process flow defined at the first application.

2. The method of claim 1, comprising:
training the calibration model based on training data generated for a set of data attributes indicative of the execution context at the first application, wherein the training data includes data associated with collected historical observations from the execution context of the first application.

3. The method of claim 2, wherein the calibration model is trained to predict an error level of the evaluation metric of the machine learning model when providing predictions based on input data associated with executed process flows at the first application.

4. The method of claim 1, wherein providing the instructions comprises:
providing the output together with a label indicative of the accuracy of the output to the first application for execution of the process flow, wherein the label is determined based on the adjusted evaluation metric.

5. The method of claim 4, wherein the first application is configured to execute the process flow based on obtaining data from a user and the output of the execution of the machine learning model.

6. The method of claim 1, wherein providing the instructions comprises:
querying the machine learning model to generate the output based on a request received from the first application, the machine learning model being conditioned based on at least a portion of the obtained input data related to the process flow.

7. The method of claim 1, wherein the first application includes a user interface associated with tabular data objects stored at a respective storage associated with a user interface form, wherein each data object of the tabular data object corresponds to a respective user interface field of the user interface form, wherein providing the instructions comprises:
displaying the output in an associated field of the user interface fields on the user interface form during executing the process flow associated with the user interface form.

8. The method of claim 1, wherein the execution context of the first application for which the error of the evaluation metric is estimated is a first execution context of a plurality of different execution contexts of the first application, and wherein the method comprises:
exposing an interface to process requests for evaluating evaluation metrics associated with the machine learning model, wherein the evaluating of the evaluation metrics is performed for the plurality of different execution contexts of the first application;
in response to determining that the adjusted evaluation metric for the first execution context of the first application is below the threshold value, providing an instruction to re-train the machine learning model based on training data associated with the first execution context.

9. A non-transitory, computer-readable medium storing one or more instructions executable by a computer system to perform one or more operations, comprising:
obtaining an evaluation metric indicative of accuracy of outputs of a machine learning model;
determining an adjustment for the evaluation metric based on invoking a calibration model to estimate an error of the evaluation metric of the machine learning model, wherein the error is estimated in an execution context of a first application running in a platform environment;
adjusting the evaluation metric according to the determined adjustment; and
in response to determining the adjusted evaluation metric is above a threshold value, providing instructions to provide an output of an execution of the machine learning model based on input data obtained from the execution context of the first application, the input data being related to a process flow defined at the first application.

10. The non-transitory, computer-readable medium of claim 9, further storing instructions, which when executed by the computer system are configured to perform operations comprising:
training the calibration model based on training data generated for a set of data attributes indicative of the execution context at the first application, wherein the training data includes data associated with collected historical observations from the execution context of the first application.

11. The non-transitory, computer-readable medium of claim 10, wherein the calibration model is trained to predict an error level of the evaluation metric of the machine learning model when providing predictions based on input data associated with executed process flows at the first application.

12. The non-transitory, computer-readable medium of claim 9, wherein providing the instructions comprises:
providing the output together with a label indicative of the accuracy of the output to the first application for execution of the process flow, wherein the label is determined based on the adjusted evaluation metric.

13. The non-transitory, computer-readable medium of claim 12, wherein the first application is configured to execute the process flow based on obtaining data from a user and the output of the execution of the machine learning model.

14. The non-transitory, computer-readable medium of claim 9, wherein providing the instructions comprises:
querying the machine learning model to generate the output based on a request received from the first application, the machine learning model being conditioned based on at least a portion of the obtained input data related to the process flow.

15. The non-transitory, computer-readable medium of claim 9, wherein the first application includes a user interface associated with tabular data objects stored at a respective storage associated with a user interface form, wherein each data object of the tabular data object corresponds to a respective user interface field of the user interface form, wherein providing the instructions comprises:
displaying the output in an associated field of the user interface fields on the user interface form during executing the process flow associated with the user interface form.

16. The non-transitory, computer-readable medium of claim 9, wherein the execution context of the first application for which the error of the evaluation metric is estimated is a first execution context of a plurality of different execution contexts of the first application, and wherein the computer-readable medium further store instructions, which when executed by the computer system cause the computer system to perform operations comprising:
exposing an interface to process requests for evaluating evaluation metrics associated with the machine learning model, wherein the evaluating of the evaluation metrics is performed for the plurality of different execution contexts of the first application;
in response to determining that the adjusted evaluation metric for the first execution context of the first application is below the threshold value, providing an instruction to re-train the machine learning model based on training data associated with the first execution context.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
obtaining an evaluation metric indicative of accuracy of outputs of a machine learning model;
determining an adjustment for the evaluation metric based on invoking a calibration model to estimate an error of the evaluation metric of the machine learning model, wherein the error is estimated in an execution context of a first application running in a platform environment;
adjusting the evaluation metric according to the determined adjustment; and
in response to determining the adjusted evaluation metric is above a threshold value, providing instructions to provide an output of an execution of the machine learning model based on input data obtained from the execution context of the first application, the input data being related to a process flow defined at the first application.

18. The system of claim 17, wherein the machine-readable media stores further instructions, which when executed by the computer system are configured to perform operations comprising:
training the calibration model based on training data generated for a set of data attributes indicative of the execution context at the first application, wherein the training data includes data associated with collected historical observations from the execution context of the first application.

19. The system of claim 17, wherein the calibration model is trained to predict an error level of the evaluation metric of the machine learning model when providing predictions based on input data associated with executed process flows at the first application.

20. The system of claim 17, wherein providing the instructions comprises:
providing the output together with a label indicative of the accuracy of the output to the first application for execution of the process flow, wherein the label is determined based on the adjusted evaluation metric.
